(19) United States
(12) Patent Application Publication
(10) Pub. No.: US 2020/0226654 A1
(43) Pub. Date: Jul. 16, 2020

(54) INFORMATION PROCESSING APPARATUS FOR SERVICE REQUEST PROCESSING AND INFORMATION PROCESSING METHOD FOR SERVICE REQUEST PROCESSING

(71) Applicant: TOSHIBA TEC KABUSHIKI KAISHA, Tokyo (JP)

(72) Inventor: Atsushi OKAMURA, Mishima Shizuoka (JP)

(21) Appl. No.: 16/691,032

(22) Filed: Nov. 21, 2019

(30) Foreign Application Priority Data
Jan. 10, 2019 (JP) 2019-002514

(51) Int. Cl. G06Q 30/06; H04N 5/247; G08B 3/10; G06K 9/00; G06Q 30/02

(52) U.S. Cl. CPC G06Q 30/0613; H04N 5/247; G06Q 30/0281; G06K 9/00342; G08B 3/10

(57) ABSTRACT

An information processing apparatus includes a plurality of cameras to capture images of regions of a floor space, such as a shop floor or the like. A server is configured to receive image data from the plurality of cameras and process the received image data. A communication terminal is connected to the server, which the is configured to detect a direction a person in the floor space is facing and a predetermined gesture of the person based on the received image data. The server determines whether the person has made an attendant request based on the detected direction the person is facing and a length of time the person has continuously made the predetermined gesture. Upon determining that the person has made the attendant request, the server sends a notification to the communication terminal.

### CROSS-REFERENCE TO RELATED APPLICATION

This application is based upon and claims the benefit of priority from Japanese Patent Application No. 2019-002514, filed on Jan. 10, 2019, the entire contents of which are incorporated herein by reference.

### FIELD

Embodiments described herein relate generally to an information processing apparatus and an information processing method for processing service requests by persons on a shop floor or the like.

### BACKGROUND

In a store having a large selling floor area, such as a home improvement store or a household appliance seller, store clerks can be allocated across the selling floor to answer inquiries or the like from customers. However, a customer may not always be able to immediately call a store clerk because, for example, the number of store clerks is low or the nearest store clerks are hidden from view behind commodity displays, product shelves, or the like.

Recently, introduction of unmanned (automated) stores has been examined, but mainly for a business type such as a convenience store. One of the problems with the unmanned stores is, if a customer encounters trouble in the store, a staff member may not be available or able to quickly rush to the site and handle the problem for the customer.

### DESCRIPTION OF THE DRAWINGS

FIG. 1 is a schematic diagram illustrating a layout example of a store according to an embodiment.

FIG. 2 is a block diagram illustrating aspects of a server.

FIG. 3 is a schematic diagram illustrating a data structure of a main data table stored in the server.

FIG. 4 is a flowchart illustrating aspects of processing executed by a processor of the server according to an information processing program.

### DETAILED DESCRIPTION

An embodiment provides a system that can recognize that a customer seeks attention of a store clerk or the like.

In general, according to an embodiment, an information processing apparatus comprises a plurality of cameras to capture images of regions of a floor space, a server configured to receive image data from the plurality of cameras and process the received image data, and a communication terminal connected to the server. The server is configured to: detect a direction a person in the floor space is facing and a predetermined gesture of the person based on the received image data and to determine whether the person has made an attendant request based on the detected direction the person is facing and a length of time the person has continuously made the predetermined gesture. Upon determining that the person has made the attendant request, the server sends a notification to the communication terminal.

An example embodiment of a system that can recognize that a first object seeks attendance of a second object is described below with reference to the drawings.

In an embodiment, a system that can recognize that a customer on a selling floor of a store seeks a store clerk is illustrated. That is, the first object is the customer (a person) and the second object is the store clerk (a person). In this context, it is assumed that a customer seeking attendance of a store clerk raises a hand for three seconds or more as a predetermined gesture established as a policy of the store. The customer may raise either the right hand or the left hand.

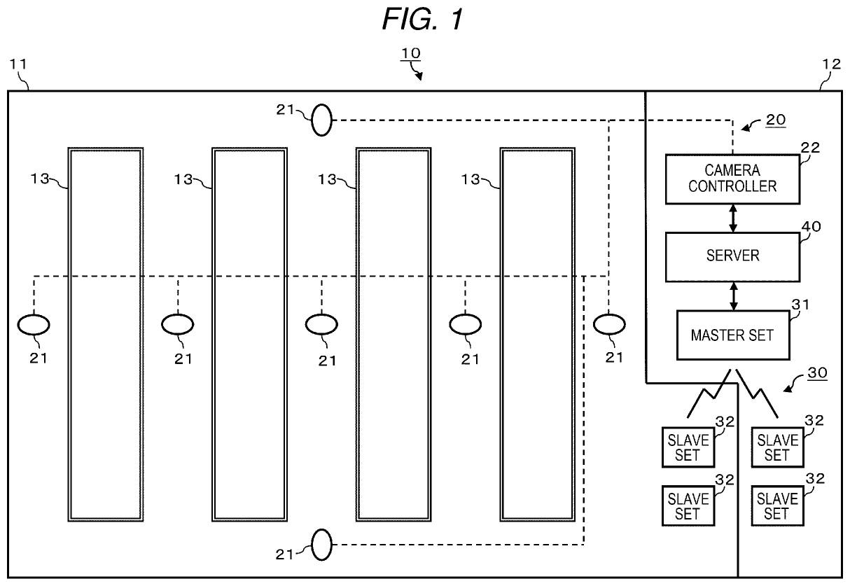

FIG. 1 is a schematic diagram illustrating a layout example of a store 10 according to an embodiment. The store 10 includes a selling floor 11 and a backroom 12 other than the selling floor 11. A plurality of product shelves 13 are disposed in the selling floor 11. Passages (e.g., aisles) for customers are formed between the product shelves 13 and/or between the product shelves 13 and walls. A customer entering the store moves around the passages of the selling floor 11, takes items (commodities) from the product shelves 13 that the customer desires to purchase, and puts the selected items in a shopping cart or the like. The customer finishing the shopping, then performs sales transaction settlement in an settlement place provided in a part of the selling floor 11.

In the store 10 having such a configuration, a monitoring system 20, an intercom system 30, and a server 40 (e.g., control terminal) functioning as an information processing apparatus are provided in order to enable, if a customer present in the selling floor 11 seeks attendance of a store clerk, the store clerk quickly go to the customer and attend the customer.

The monitoring system 20 includes a plurality of cameras 21 and a camera controller 22 that controls the cameras 21. The cameras 21 are set for each of the passages to be able to cover the entire region of the passages of the selling floor 11 as a photographing region. The cameras 21 are monitoring cameras attached with speakers. The number and attachment places of the cameras 21 are not particularly limited. In short, the cameras 21 only have to be able to cover the entire region of the passages as the photographing region and photograph behavior of customers present in the passages. In the present embodiment, for convenience of explanation, one camera 21 is set in one passage as illustrated in FIG. 1.

The camera controller 22 is connected to the cameras 21 via wired communication or wireless communication to control a photographing operation of the cameras 21. The camera controller 22 receives image signals photographed by the cameras 21. The camera controller 22 transmits a voice signal to one camera 21 designated by the server 40. In the camera 21 that receives the voice signal, voice is generated from the speaker provided in the camera 21.

The intercom system 30 is an internal communication system and includes a master set 31 and a plurality of slave sets 32. The master set 31 covers the entire region of the store 10 including the selling floor 11 and the backroom 12 and enables wireless communication with the slave sets 32 present in the region. The slave sets 32 are, for example, mobile terminals, such as transceivers attached with headsets, headphones, or earphones. The store clerks responsible for attending to the store customers each wear a slave set 32. The store clerks responsible for customer attendance are present in the selling floor 11 or the backroom 12 while wearing the slave sets 32. If commands transmitted from the master set 31 are received by the slave sets 32, the store clerks can perform various actions corresponding to the commands.

The server 40 has functions of a recognizing section to recognize a gesture of a customer, a determining section that determines a direction that the customer is facing, a deciding section that decides whether an attendance action by a store clerk has been requested according to the direction that the customer faces and the gesture by the customer, and an informing section that notifies the store clerk of an attendance action request. The server 40 also functions as a measuring section that measures a continuation time of the gesture, a detecting section that detects a position of the customer whose gesture is recognized, and a notifying section that notifies the customer that the gesture for an attendance action has been recognized. The server 40 connects to the camera controller 22 and the master set 31 in order to perform these functions. The server 40 can be implemented with an information processing program as described below.

In FIG. 1, the camera controller 22, the master set 31, and the server 40 are illustrated as being provided in the backroom 12. However, these devices do not always have to be provided in the backroom 12. For example, the camera controller 22 may be provided on the selling floor 11 so long as the camera controller 22 can transmit and receive signals between the camera controller 22 and the cameras 21. The master set 31 may be provided on the selling floor 11 so long as the master set 31 can wirelessly communicate with the slave sets 32 worn by the store clerks in the store 10. The server 40 may be provided in a cloud computing environment that provides computer resources via a network such as the Internet.

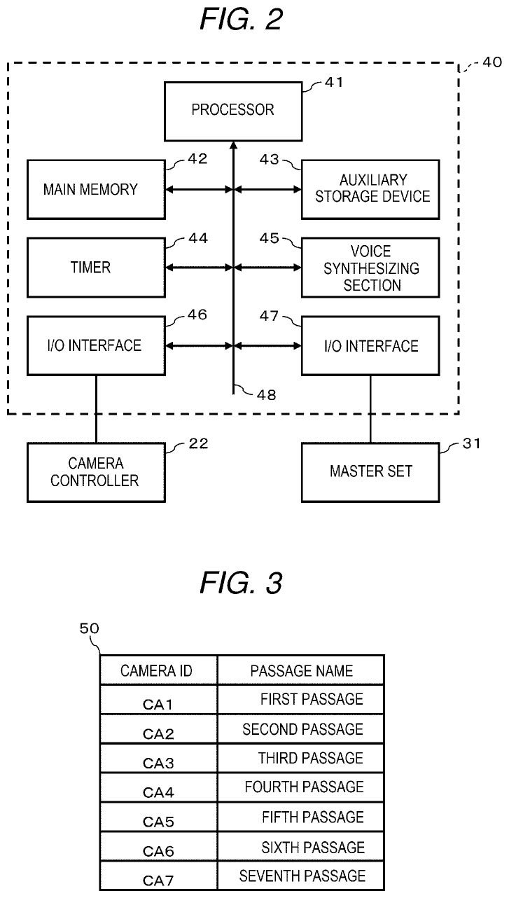

FIG. 2 is a block diagram illustrating a configuration of the server 40. The server 40 includes a processor 41, a main memory 42, an auxiliary storage device 43, a timer 44, a voice synthesizing section 45, a first I/O (Input/Output) interface 46, a second I/O interface 47, and a system transmission line 48. The system transmission line 48 includes an address bus, a data bus, and a control signal line. In the server 40, the processor 41, the main memory 42, the auxiliary storage device 43, the timer 44, the voice synthesizing section 45, and the first and second I/O interfaces 46 and 47 are connected to the system transmission line 48. In the server 40, a computer is configured by the processor 41, the main memory 42, and the auxiliary storage device 43 and the system transmission line 48 that connects these devices.

The processor 41 is equivalent to a central part of the computer. The processor 41 controls the sections according to an operating system or application programs in order to perform various functions of the server 40. The processor 41 is, for example, a CPU (Central Processing Unit).

The main memory 42 is equivalent to a main storage portion of the computer. The main memory 42 includes a nonvolatile memory region and a volatile memory region. The main memory 42 stores the operating system or the application programs in the nonvolatile memory region. The application programs include an information processing program described below. The main memory 42 sometimes stores, in the volatile or nonvolatile memory region, data necessary for the processor 41 to execute processing for controlling the sections. The main memory 42 uses the volatile memory region as a work area where data is rewritten as appropriate by the processor 41. The nonvolatile memory region is, for example, a ROM (Read Only Memory). The volatile memory region is, for example, a RAM (Random Access Memory).

The auxiliary storage device 43 is equivalent to an auxiliary storage portion of the computer. For example, an EEPROM (Electric Erasable Programmable Read-Only Memory), an HDD (Hard Disc Drive), or an SSD (Solid State Drive) can be the auxiliary storage device 43. The auxiliary storage device 43 saves data used by the processor 41 in performing various kinds of processing, data created by the processing in the processor 41, or the like. The auxiliary storage device 43 sometimes stores the application programs including the information processing program described below.

The timer 44 performs a clocking operation according to a command from the processor 41. If clocking a preset timeout time, the timer 44 stops the clocking operation.

The voice synthesizing section 45 has a function of synthesizing first voice data to be emitted from the speakers attached to the cameras 21 of the monitoring system 20 and a function of synthesizing second voice data to be emitted from the slave sets 32 of the intercom system 30.

The first I/O interface 46 performs transmission and reception of data signals between the first I/O interface 46 and the camera controller 22. The second I/O interface 47 performs transmission and reception of data signals between the second I/O interface 47 and the master set 31.

The server 40 stores, in the main memory 42 or the auxiliary storage device 43, a data table 50 having a data structure illustrated in FIG. 3. As illustrated in FIG. 3, the data table 50 records passage (aisle) names respectively in association with a plurality of camera IDs.

The camera IDs are unique codes individually allocated to each of the cameras 21 monitoring the selling floor 11. The camera ID set in each of the cameras 21 is associated with the image data provided by the respective camera 21 and transmitted to the camera controller 22.

The passage names are unique names set for the passages in the photographing region covered by the cameras 21 specified by the camera IDs corresponding thereto. Different passage names, for example, “first passage” and “second passage” are set in advance for the passages of the selling floor 11. In general, simply by hearing a passage name, the store clerks can recognize at which place on the selling floor 11 a referenced passage is located.

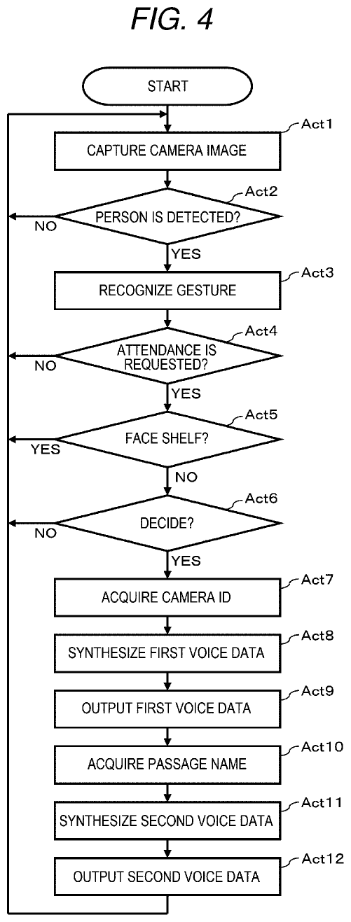

FIG. 4 is a flowchart illustrating a procedure of processing executed by the processor 41 of the server 40 according to the information processing program. The functions of the server 40 are specifically described below with reference to FIG. 4. Content described below is an example. The procedure and the content are not particularly limited if the same functions can be obtained.

In Act 1, the processor 41 obtains camera image data. That is, the processor 41 sequentially obtains, in a time division manner, image data photographed by the cameras 21 from the camera controller 22 via the first I/O interface 46. Every time the processor 41 obtains image data, in Act 2, the processor 41 analyzes the image data and determines whether a person, who is an object, is photographed. If a person is not photographed, the processor 41 determines NO in Act 2 and the process returns to Act 1. In Act 1, the processor 41 obtains the next image data from the camera controller 22.

If a person is photographed by the camera 21, the processor 41 determines YES in Act 2 and the process proceeds to Act 3. In Act 3, the processor 41 recognizes a gesture of the person from the image data photographed by the camera 21. In Act 4, the processor 41 determines whether a gesture, established in advance as an attendant request from a customer, such as, a hand-raising gesture by the customer has been recognized. For example, if detecting from the image data that the fingertip of one hand is raised higher than the head, the processor 41 determines that the gesture set as the attendant request is recognized. If the gesture set as the attendant request is not recognized, the processor 41 determines NO in Act 4 and the process returns to Act 1. In Act 1, the processor 41 obtains the next image data from the camera controller 22.

If the gesture set as the attendant request is recognized, the processor 41 determines YES in Act 4 and the process proceeds to Act 5. In Act 5, the processor 41 determines from the image data whether the customer faces a product shelf 13. If the customer faces a product shelf 13, the processor 41 determines Yes in Act 5 and the process returns to Act 1. In Act 1, the processor 41 obtains the next image data from the camera controller 22.

If the customer does not face a commodity shelf 13, the processor 41 determines NO in Act 5 and the process proceeds to Act 6. In Act 6, the processor 41 determines whether an action by a store clerk in response to the attendant request gesture is required. Specifically, the processor 41 starts the timer 44 and continuously obtains image data of the cameras 21 in which the person performing the gesture is photographed. The processor 41 confirms whether the gesture has been continued until the timer 44 times out. In the present embodiment, a timeout time of the timer 44 is set to occur at three seconds. If a person not facing the product shelf 13 continues the attendant request gesture for three seconds, the processor 41 determines that an attendance action by the store clerk in response to the attendant request gesture is necessary. If the gesture is not continued for three seconds, the processor 41 determines NO in Act 6 and the process returns to Act 1. In Act 1, the processor 41 obtains the next image data from the camera controller 22.

If the gesture set as the attendant request is continuously recognized in the image data until the timer 44 times out, the processor 41 determines YES in Act 6 and the process proceeds to Act 7. In Act 7, the processor 41 acquires a camera ID of the camera 21 at a transmission source of the image data. The camera ID is attached to the image data.

In Act 8, the processor 41, which has acquired the camera ID, instructs the voice synthesizing section 45 to synthesize first voice data. The first voice data is a voice message responding from the store side to the person, that is, the customer, who made the attendant request gesture. Voice messages such as “please wait a while”, “I understand”, or “the store clerk will see you soon” are examples of the first voice data.

If the first voice is synthesized by the voice synthesizing section 45, in Act 9, the processor 41 controls the camera controller 22 to output data of the first voice to the camera 21 identified by the camera ID acquired in Act 7. According to the control, the first voice is generated from the speaker of the camera 21.

In Act 10, the processor 41, which acquires the camera ID, searches through the data table 50 with the camera ID and acquires a passage name associated with the camera ID. In Act 11, the processor 41 instructs the voice synthesizing section 45 to synthesize second voice including the passage name. The second voice data is a voice message for notifying the store clerk to take the attendance action because the customer present in the passage of the passage name is requesting attendance. Voice messages such as “a customer is calling in the first passage” or “please go to the second passage” are examples of the second voice data.

If the second voice is synthesized by the voice synthesizing section 45, in Act 12, the processor 41 controls the master set 31 to output data of the second voice to the slave sets 32 respectively worn by the store clerks. According to the control, the second voice data is emitted from the slave sets 32 all at once.

If ending the processing of Act 7 to Act 12 in this way, the process returns to Act 1. Thereafter, the processor 41 repeatedly executes the processing of Act 1 to Act 12.

In the server 40, the processor 41 executes the processing of Act 3 and Act 4, whereby the function of the recognizing section is performed. The processor 41 executes the processing of Act 5, whereby the function of the determining section is performed. The processor 41 executes the processing of Act 6 in cooperation with the timer 44, whereby the functions of the measuring section and the deciding section are performed. The processor 41 executes the processing of Act 7 and Act 10, whereby the function of the detecting section is performed. The processor 41 executes the processing of Act 11 and Act 12, whereby the function of the informing section is performed. The processor 41 executes the processing of Act 8 and Act 9, whereby the function of the notifying section is performed.

In the store 10 including the server 40 having such functions, for example, if a customer present in the first passage of the selling floor 11 faces a direction not facing the product shelf 13 and raises a hand for three seconds, voice “a customer is calling in the first passage” is generated all at once from the slave sets 32 respectively worn by the store clerks. Therefore, the store clerks can know that the customer is seeking attendance in the first passage. At this time, a store clerk closest to the first passage can quickly cope with an inquiry or a trouble of the customer by responding to the customer. As a result, service quality of the store 10 can be improved. Therefore, an increase in the number of customers visiting the store and an increase in sales can be expected.

For example, if a customer present in the first passage of the selling floor 11 faces a direction not facing the product shelf 13 and raises a hand for three seconds, voice message “please wait a while” is emitted from the speaker of the camera 21 that monitors the first passage. Therefore, the customer performing the gesture for the attendant request can know that the attendant request has been conveyed to the store 10. As a result, the customer will not feel uneasy about whether the gesture for the attendant request was correct or appropriately received. Therefore, a good impression can be given to the customer.

If a customer faces the product shelf 13 and raises a hand, the server 40 will determine that such an act is not an attendant request since usually a customer that faces a product shelf 13 and raises one hand is just taking down an item displayed on an upper shelf of the product shelf 13. As such, the server 40 does not include such an act by the customer as an attendant request. Therefore, it is possible to more accurately recognize the attendant requests.

The server 40 decides, by considering a continuation time of the gesture, whether the store clerk should perform an attendance action. For example, as a scenario in which the customer faces away from a product shelf 13 and raises a hand to call over or hail a friend is conceivable. However, in such a scenario, the customer is unaware of a continuation time of a gesture. Therefore, for example, if the customer does not raise a hand for three seconds or more, it is determined that the gesture was not an attendant request. Therefore, the recognition accuracy of the attendant request can be improved in this respect as well.

In the present embodiment, the attendant request from the customer is informed to the store clerks using the intercom system 30. The intercom system 30 can be a well-known system and has already been introduced in many stores. Therefore, such stores can introduce the function of the present embodiment using the existing system. Therefore, there is an advantage that cost can be reduced.

The embodiment of the information processing apparatus that can recognize that the first object seeks the attendance of the second object is described above. However, such an embodiment is not limited to this.

In the embodiment, the server 40 includes the detecting section that detects a position where a customer whose gesture is recognized is present. The detecting section is effective if the present embodiment is applied to a store having a large selling floor area such as a do-it-yourself store or a household electric appliance volume seller. However, if the present embodiment is introduced into a store having a small selling floor area such as an unmanned convenience store, it is not always necessary to detect a position where a customer is present. The server 40 only has to be able to recognize that a customer is performing a gesture for an attendant request without facing a product shelf. Therefore, the detecting section can be excluded from the server 40.

In the present embodiment, a plurality of store clerks can be informed all at once using the slave sets 32 of the intercom system 30 of the need for an attendance action. The informing section is not limited to intercom system 30. For example, portable communication terminals, such as smartphones, carried by the store clerks can be utilized as an informing section. It is also possible use one or more display devices in a predetermined place of the selling floor 11 or the backroom 12 to notify store clerks by causing the display device(s) to display an image for notifying the store clerks. In such a case, a digital signage terminal on the selling floor 11 or the like used for an in-store advertisement or otherwise can be used as the display device.

In the example embodiment, it is possible to recognize that a customer on the selling floor of a store seeks assistance from a store clerk. However, the present disclosure is not limited to this. For example, if a workman in a factory or on a factory floor cannot leave a workshop area or the like, but seeks attendance of a responsible person (supervisor), the information processing apparatus of the present disclosure can also be applied. In this case, the first object is the workman and the second object is the responsible person.

Furthermore, the present disclosure is not limited to a person seeking assistance from another person. For example, either of the first or second objects may be a robot or an animal. For example, the first object may be a person and the second object may be a robotic store attendant or the like.

In the present embodiment, as an example, the information processing program is stored in advance in the main memory 42 or the auxiliary storage device 43 of the server 40, which is a form of the information processing apparatus. As another embodiment, by installing the information processing program in a computer not initially storing the information processing program, it is also possible to cause the computer to function as the information processing apparatus. In this case, the information processing program may be transferred separately from the information processing apparatus in a writable storage device to be included in the information processing apparatus according to, for example, operation of a user. The loading of the information processing program can be performed by recording the information processing program in a removable recording medium or by communication via a network. A format of the recording medium may be any format so long as the recording medium can store the program and the apparatus can read the recording medium. For example, a CD-ROM, a memory card, or the like can be utilized.

While certain embodiments have been described, these embodiments have been presented by way of example only, and are not intended to limit the scope of the present disclosure. Indeed, the novel embodiments described herein may be embodied in a variety of other forms; furthermore, various omissions, substitutions and changes in the form of this embodiments described herein may be made without departing from the spirit of the present disclosure. The accompanying claims and their equivalents are intended to cover such forms or modifications as would fall within the scope and spirit of the present disclosure.

What is claimed is:

1. An information processing apparatus, comprising:
a plurality of cameras to capture images of regions of a floor space;
a server configured to receive image data from the plurality of cameras and process the received image data; and
a communication terminal connected to the server, wherein the server is configured to:
detect a direction a person in the floor space is facing and a predetermined gesture of the person based on the received image data;
determine whether the person has made an attendant request based on the detected direction the person is facing and a length of time the person has continuously made the predetermined gesture; and
upon determining that the person has made the attendant request, send a notification to the communication terminal.

2. The information processing apparatus according to claim 1, wherein
the person is a customer,
the floor space is a selling floor of a store,
the regions correspond to store aisles between product shelves,
the communication terminal is a mobile terminal of a store clerk, and
the notification is voice message identifying the store aisle in which the customer is located.

3. The information processing apparatus according to claim 1, wherein the predetermined gesture is a raising of a hand.

4. The information processing apparatus according to claim 1, wherein the notification indicates a region in which the person making the predetermined gesture is located.

5. The information processing apparatus according to claim 4, wherein
each camera in the plurality of cameras includes a speaker,
the notification is sent to a camera corresponding to the region in which the person is located, and
the speaker of the camera receiving the notification emits a voice message according to the notification.

6. The information processing apparatus according to claim 1, wherein
each camera in the plurality of cameras includes a speaker,
the notification is sent to a camera corresponding to the region in which the person is located, and
the speaker of the camera receiving the notification emits a voice message according to the notification.

7. The information processing apparatus according to claim 1, wherein the communication terminal is connected to an intercom system covering the floor space.

8. The information processing apparatus according to claim 7, wherein intercom system comprises a master terminal and a plurality of mobile terminals.

9. The information processing apparatus according to claim 1, wherein the server is in a backroom adjacent to the floor space.

10. The information processing apparatus according to claim 1, further comprising:
a camera controller connected to the plurality of cameras and configured to provide the image data to the server.

11. The information processing apparatus according to claim 1, wherein the server comprises a processor, a storage device, and an input/output interface.

12. The information processing apparatus according to claim 1, wherein the communication terminal comprises a display screen visible from the floor space.

13. The information processing apparatus according to claim 1, wherein at the communication terminal is a handheld communication device.

14. The information processing apparatus according to claim 1, wherein the server is configured to ignore the detection of the predetermined gesture if the detected direction corresponds to the person facing towards a product shelf.

15. A method for service request processing, the method comprising:
receiving image data from a plurality of cameras capturing images of regions of a floor space;
detecting a direction a person in the floor space is facing and a predetermined gesture of the person based on the received image data;
determining whether the person has made an attendant request based on the detected direction the person is facing and a length of time the person has continuously made the predetermined gesture; and
upon determining that the person has made the attendant request, sending a notification to a communication terminal.

16. The method according to claim 15, wherein
the person is a customer,
the floor space is a selling floor of a store,
the regions correspond to store aisles between product shelves,
the communication terminal is a mobile terminal of a store clerk, and
the notification is voice message identifying the store aisle in which the customer is located.

17. The method according to claim 15, wherein the predetermined gesture is a raising of a hand.

18. The method according to claim 15, wherein
each camera in the plurality of cameras includes a speaker,
the notification is sent to a camera corresponding to the region in which the person is located, and
the speaker of the camera receiving the notification emits a voice message according to the notification.

19. The method according to claim 18, wherein the communication terminal is connected to an intercom system covering the floor space.

20. The method according to claim 19, intercom system comprises a master terminal and a plurality of mobile terminals.
